(19) United States
(12) Patent Application Publication
(10) Pub. No.: US 2025/0376232 A1
(43) Pub. Date: Dec. 11, 2025

(54) Motor Vehicle, in Particular Motorcycle or Tilting Vehicle

(71) Applicant: Bayerische Motoren Werke Aktiengesellschaft, Muenchen (DE)

(72) Inventors: Armin HIRN, Neuried (DE); Matthias KOTTMANN, Muenchen (DE); Jochen WEINELT, Reichertshausen (DE)

(21) Appl. No.: 18/877,053

(22) PCT Filed: Aug. 9, 2023
(86) PCT No.: PCT/EP2023/072008

§ 371 Date: Dec. 19, 2024

(30) Foreign Application Priority Data
Sep. 14, 2022 (DE) 10 2022 123 417.7

(51) Int. Cl. B62J 17/10; B62J 17/02

(52) U.S. Cl. CPC B62J 17/10; B62J 17/02

(57) ABSTRACT

A motor vehicle, in particular a motorcycle or other type of tilting vehicle, has at least one lateral adjustable fairing part which is movable translationally from a first position into a second position, wherein the second position is offset relative to the first position at least along a vertical axis of the motor vehicle.

### BACKGROUND AND SUMMARY

The present invention relates to a motor vehicle, in particular a motorcycle or a tilting vehicle such as, for example, a motorbike.

It is known from the prior art that motorcycles such as motorbikes have fairings which are configured to protect the driver from the airstream. Moreover, air directing elements, which are variable in terms of their orientation and can be adjusted according to the situation or the requirement, are known. For example, DE 10 2020 125 060 A1 discloses a motorcycle having an adjustable directing element which is supported on a body and/or vehicle structure so as to be movable in a relative manner between a deployed position and a retracted position. In terms of the aerodynamic possibilities, this approach does appear to be very promising but has not yet been fully exploited.

It is, therefore, an object of the present invention to provide a motor vehicle, in particular a motorcycle or a tilting vehicle, which has an adjustable air directing element or fairing part, wherein the known solutions are to be further optimized.

This object is achieved by a motor vehicle according to the independent claim(s). Further advantages and features are derived from the dependent claims and from the description and the appended figures.

According to the invention, a motor vehicle, in particular a motorcycle or tilting vehicle, comprises at least one lateral adjustable fairing part which is displaceable in a translatory manner from a first position to a second position, wherein the second position is offset relative to the first position at least along a vertical axis of the motorcycle. The fairing part is expediently displaceable or repositionable from the first position to the second position as an entity. Therefore, the fairing part does not change, or not only change, its orientation, but “departs” from its “original position”, so to speak. The fairing part, which may also be referred to as an air directing element, is displaced to the second position which is expediently offset at least along the vertical axis of the motorcycle while entirely or at least partially departing from the original first position.

According to one embodiment, the motor vehicle is a single-track or multiple-track motor vehicle, particularly preferably a motorcycle such as, for example, a motorbike or a motor scooter, wherein the terms “motorcycle” or “tilting vehicle” also include quads, trikes, three-wheelers, LNM (leaning multi-wheel) vehicles, etc. Without limiting the general aspect, only the term “motorcycle” will be used hereunder.

According to one preferred embodiment, the fairing part in the second position is configured to protect a driver of the motorcycle, in particular his/her upper body half, particularly preferably the torso, from an airstream. It is to be mentioned at this point that the motorcycle preferably has two lateral adjustable fairing parts, in particular thus a corresponding fairing part on each side, which is displaceable in a translatory manner from the first position to the second position. According to one embodiment, a plurality of adjustable fairing parts of this type are also disposed on each side. The arrangement is preferably always performed symmetrically, there thus being the same number of fairing parts of the same design on each side.

Moving the fairing parts “upward” (along the vertical axis) advantageously enables the protection of the driver from the airstream. The second position is thus provided in particular for comparatively high speeds. In the first position, in which the lateral fairing parts rest for example on a fairing, or else on the frame, etc., of the motorcycle, positive cooling of the driver can advantageously be achieved. The lateral fairing part thus expediently acts as an air directing element which, in particular in the second position, is configured to guide an airstream in such a manner that the latter is directed about a driver. The geometry of the fairing part here is expediently chosen in such a way that an aerodynamically optimal function is provided also at the first position, either in terms of positive aerodynamics and/or else in terms of ideally positive cooling, for example of the driver or else of a drive of the motorcycle, the drive potentially comprising an electric motor or else an internal combustion engine.

According to one embodiment, the aforementioned fairing is a full fairing or a partial fairing of a motorbike, or else of a motor scooter.

According to one preferred embodiment, the at least one lateral fairing part, when viewed along a direction of travel, has a length of at least 15 cm, preferably at least 20 cm. A height measured along the vertical axis here is expediently at least 10 cm, in particular at least 20 cm, for example. According to one preferred embodiment, the fairing part has, for example, a length of approximately 20 to 30 cm, and a height of approximately 25 to 35 cm. According to a further preferred embodiment, the fairing part has a length of approximately 30 to 40 cm, and a height of approximately 25 to 30 cm.

The present exemplary embodiments demonstrate that the fairing part is expediently of a relatively large design. In this way, inter alia, a very effective protection of the driver from the airstream can be achieved.

According to one embodiment, the motorcycle comprises an adjustment mechanism which is conceived to displace the fairing part at least along the vertical axis. For example, the adjustment mechanism comprises kinematics or a linkage configured for displacing the fairing part. The adjustment mechanism expediently also comprises one or a plurality of drives which are developed to cause the displacement. Drives can be mechanical drives such as, for example, spring elements. Drive elements can however also be motorized drives such as, for example, electric drives and/or hydraulic and/or pneumatic drives.

According to one embodiment, the adjustment mechanism has at least one rotating arm or comprises a latter, wherein the rotating arm has a rotation axis which is oriented perpendicularly, or substantially perpendicularly, to the vertical axis. In particular, the aforementioned rotation axis is also, or substantially also, oriented perpendicularly to the direction of travel. The rotating arm, which can also be referred to as a swivel arm, enables the fairing part to be rotated or pivoted from the first position to the second position, in particular along a circular path.

According to one embodiment, the adjustment mechanism has a rail system which is configured to displace, or in particular to slide, the fairing part at least along the vertical axis.

According to one embodiment, the fairing part can be displaced exclusively along the vertical axis. According to a preferred embodiment, displacing is performed along the vertical axis and counter to or along the direction of travel. A movement counter to the direction of travel, thus toward the driver, can under certain circumstances enable an even better protection of the driver from the airstream. Moreover, a movement toward the outside (and back again) in terms of a central axis of the vehicle may also be advantageous.

According to one embodiment, the fairing part can also assume intermediate positions between the first position and the second position. According to one embodiment, the position of the fairing part can be adjusted in a stepless manner. Alternatively, an incremental system can be provided, so as to enable different positions, in particular thus also intermediate positions between the first position and the second position, for example as a function of environmental conditions such as the speed of travel.

According to one embodiment, the second position is offset away relative to the first position in terms of a central axis of the motorcycle. In other words, according to one embodiment, the fairing part in the second position can be disposed further outside than in the first position. This may have aerodynamic reasons or else structural reasons, for example because a collision with a vehicle frame or the fairing would otherwise arise in the second position.

According to one embodiment, the motorcycle comprises a fairing which defines an outer skin, wherein the fairing part in the first position is integrated or embedded in the outer skin. The fairing part is expediently designed in such a manner, so to speak, that the presence of an adjustable fairing part is not visible in the first position.

According to one embodiment, the motorcycle comprises a base part on which the fairing part rests in the first position. The base part can also be referred to as a base plate. The base part comprises, for example, the aforementioned adjustment mechanism. According to one embodiment, the base part has the same, or substantially the same, or a similar, external contour as/to the fairing part; in particular, the base part has approximately the same size as the fairing part, for example.

According to one embodiment, the base part is a portion or region of a fairing of the motorcycle, or a separate element. According to one embodiment, the fairing has the aforementioned adjustment mechanism. Alternatively, the fairing has, for example, a clearance into which the base part and the fairing part are inserted. Furthermore alternatively, a motorcycle optionally does not comprise any fairing or full fairing, and the base part is fastened to a vehicle frame or the like.

According to one embodiment, the adjustment mechanism comprises a manual or electrical activation element. Different possibilities are advantageous here, depending on the drive of the fairing part. According to one embodiment, the fairing part comprises a “push-to-open” function. The displacement of the fairing part from the first position to the second position can be initiated by pressing or touching the fairing part. Sliding back the fairing part from the second position to the first position is performed manually, for example. According to a further embodiment, the adjustment can be implemented by way of the vehicle electronics/the onboard computer. For example, the driver can select a corresponding menu item in order to enable the displacement from the first to the second position, and also back again. Furthermore alternatively, the adjustment of the fairing part can also be performed fully automatically, for example as a function of speed. According to a further embodiment, the adjustment can also be completely deactivated should the driver require this.

The fairing is a so-called full fairing or else a half-fairing or partial fairing. Fairings of this type are used in so-called super sport bikes, or else in particular in so-called touring bikes or sports touring bikes. Moreover, however, motorcycles without a fairing can also expediently comprise an adjustable fairing element of this type, because the latter in the first position is expediently able to be integrated for example in a relatively inconspicuous manner and close to the motor into the silhouette of the motorbike.

Further advantages and features are derived from the description hereunder of embodiments of motorcycles or fairing parts with reference to the appended figures.

### BRIEF DESCRIPTION OF THE DRAWINGS

FIG. 1 is a schematic lateral view of an embodiment of a motorcycle according to the invention;

FIG. 2 shows the diagram known from FIG. 1, wherein the fairing part is shown in its second position;

FIG. 3 is a schematic view which shows two fairing parts, each in the first and in the second position; and

FIG. 4 is a schematic view of an embodiment of a fairing part in a first position and in a second position.

### DETAILED DESCRIPTION OF THE DRAWINGS

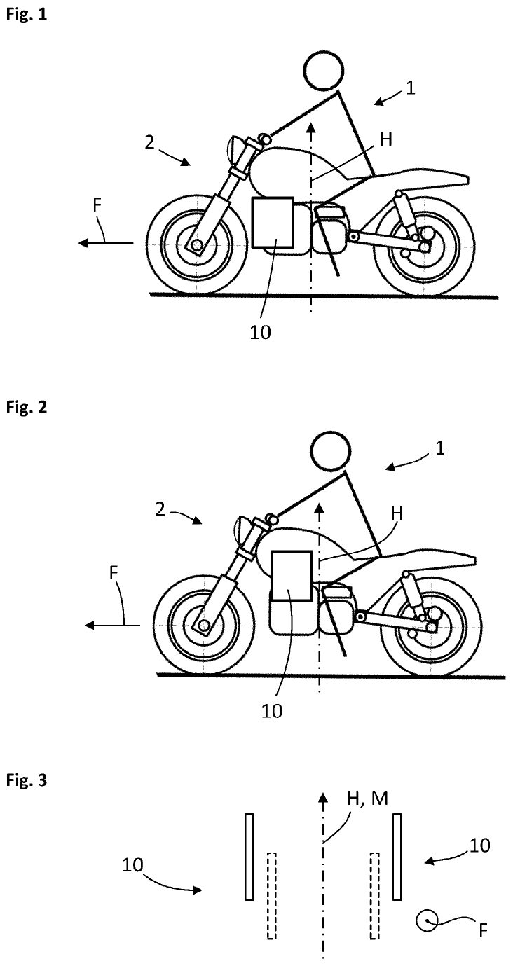

FIG. 1, in a schematic view, shows a motorbike 2 on which a driver 1 is sitting. The motorbike 2 travels along a direction of travel F. An adjustable fairing part 10 is disposed laterally on the motorbike 2. This adjustable fairing part 10 can expediently be adjusted at least along the vertical axis H. It can be achieved advantageously in this way that the driver 1, and in particular an upper body half of the driver 1, thus in particular his/her torso, are protected from the airstream.

This state is schematically illustrated in particular in FIG. 2, in which the fairing part 10 is shown in its second position. It can be seen that the fairing part 10 in comparison to FIG. 1 has moved along the vertical axis H as well as counter to the direction of travel F. In other words, it has moved toward the driver 1. Despite this presently only involving schematic diagrams, it is intended to nevertheless become evident that the fairing part 10 is expediently of a relatively large design. In this way, the size ratios shown in FIGS. 1 and 2, thus the size ratio of the fairing part 10 relative to the entire motorcycle 2, are to be considered as quite realistic.

FIG. 3 shows a schematic view of two lateral fairing parts 10, when viewed counter to a direction of travel F. For additional orientation, a vertical axis H and a central axis M are also illustrated. The fairing parts 10 are illustrated in their first position by dashed lines. FIG. 3 is intended to demonstrate that the fairing parts 10 in a second position can be oriented so as to be offset away from the central axis M, for example. This can have aerodynamic advantages, or be advantageous for structural reasons, for example in order to avoid any collision between the fairing parts 10 and other components during adjustment.

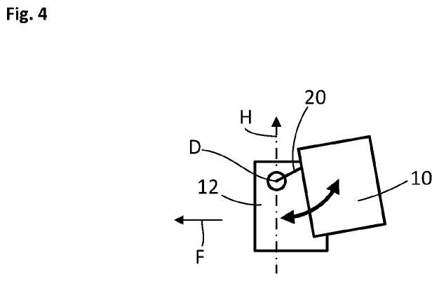

FIG. 4, in a schematic view, shows a fairing part 10 which is fastened to a base part 12 by way of a rotating arm 20. For orientation, a vertical axis H and a direction of travel F are furthermore schematically shown. The base part 12 has a substantially identical or similar shape to the fairing part 10. The base part 12 can be part of a fairing of a motorcycle not shown in more detail here. Alternatively, the base part 12 can also be a separate part which is fastened to a motorcycle. The adjustment mechanism, as schematically illustrated here, comprises a rotating arm 20. A plurality of rotating arms of this type are expediently provided. These rotating arms can be configured in such a way that the fairing part 10, as can be seen in FIG. 4, changes its alignment or orientation, for example is thus somewhat rotated, when displaced to the second position. Alternatively, an adjustment mechanism which ensures that the fairing part 10 has the same orientation or alignment in the second position as in the first position can also be used.

### LIST OF REFERENCE SIGNS

1 Driver
2 Motorcycle
10 Fairing part
12 Base part
20 Rotating arm
D Rotation axis
H Vertical axis
F Direction of travel
M Central axis

1.-10. (canceled)

11. A tilting motor vehicle, comprising:
at least one lateral adjustable fairing part which is displaceable in a translatory manner from a first position to a second position,
wherein the second position is offset relative to the first position at least along a vertical axis of the motor vehicle.

12. The motor vehicle according to claim 11, wherein
the fairing part in the second position is configured to protect a driver of the motor vehicle from an airstream.

13. The motor vehicle according to claim 12, wherein, in the second position, the fairing part protects an upper body half from the airstream.

14. The motor vehicle according to claim 11, further comprising:
an adjustment mechanism configured to displace the fairing part at least along the vertical axis.

15. The motor vehicle according to claim 13, wherein
the adjustment mechanism comprises at least one rotating arm, wherein
the rotating arm has a rotation axis which is oriented perpendicularly, or substantially perpendicularly, to the vertical axis.

16. The motor vehicle according to claim 13, wherein
the adjustment mechanism has a rail system configured to displace the fairing part at least along the vertical axis.

17. The motor vehicle according to claim 11, wherein
the second position is offset relative to the first position counter to or along a direction of travel.

18. The motor vehicle according to claim 11, further comprising:
a fairing which defines an outer skin of the motor vehicle,
wherein the fairing part in the first position is integrated in the outer skin.

19. The motor vehicle according to claim 11, further comprising:
a base part on which the fairing part rests in the first position.

20. The motor vehicle according to claim 19, wherein the base part is a portion of a fairing of the motor vehicle, or a separate element.

21. The motor vehicle according to claim 14, wherein the adjustment mechanism comprises a manual or electrical activation element.

22. The motor vehicle according to claim 11, wherein the motor vehicle is a motorcycle.
